(19) United States
(12) Patent Application Publication
(10) Pub. No.: US 2026/0084266 A1
(43) Pub. Date: Mar. 26, 2026

(54) Magnet Applicators

(71) Applicant: Magnet Baron LLC, Southlake, TX (US)

(72) Inventor: Constantine Nicholas Greanias, Southlake, TX (US)

(73) Assignee: Magnet Baron LLC, Southlake, TX (US)

(21) Appl. No.: 19/337,744

(22) Filed: Sep. 23, 2025

Related U.S. Application Data
(60) Provisional application No. 63/697,606, filed on Sep. 23, 2024.

(51) Int. Cl. B25B 11/00; B25G 1/10

(52) U.S. Cl. CPC B25B 11/002; B25G 1/102

(57) ABSTRACT

Magnet applicators may be designed to facilitate accurate magnet polarity determination and safe magnet application. These tools may feature embedded magnets with opposing magnetic fields, enabling users to ascertain polarity without additional devices. These tools may have an ergonomic design, ensuring user comfort and ease of use, and may employ color-coded indicators for polarity identification and incorporate sliding mechanisms for controlled magnet movement. Additionally, they may also include adjustable magnet separators, which may allow for the separation and application of magnets of various sizes without direct hand contact, thereby maintaining the cleanliness and effectiveness of adhesives. Protective caps may be resistant to chemicals and heat, ensuring durability and functionality in diverse environments. The inventions may address common challenges associated with magnet handling, particularly for individuals with hand strength or dexterity issues, and may provide a comprehensive solution for the safe and efficient application of magnets.

### RELATED APPLICATIONS

This application claims the benefit of U.S. Provisional Application No. 63/697,606, filed Sep. 23, 2024, the contents of which are fully incorporated herein by reference.

### BACKGROUND OF THE INVENTIONS

1. Field of the Inventions

The present inventions generally to the field of magnetic tools, specifically designed to facilitate the determination of magnet polarity and assist in the safe and efficient application of magnets. The tools are particularly beneficial for individuals with hand strength or dexterity issues, offering a comprehensive solution for handling magnets in a variety of environments.

### 2. Description of the Related Art

In the realm of hand tools and accessories, accurately determining magnet polarity and safely applying magnets onto surfaces have been persistent challenges faced by both professionals and hobbyists alike. Existing solutions typically require the use of separate polarity-checking devices, which not only add complexity and time to the process but also increase the probability of human error during the transfer of magnets to their intended destinations. This issue is compounded by the fact that handling magnets often results in the transfer of hand oils, which can significantly reduce the effectiveness of adhesives used to affix the magnets.

Moreover, strong magnets are inherently difficult and sometimes painful to separate, a task that becomes more daunting for individuals with limited hand strength or dexterity issues. Users often struggle with pinching hazards and potential injuries when attempting to manipulate these magnets directly. Traditional methods lack ergonomic designs and safety features that could mitigate such risks, leading to a suboptimal and hazardous user experience.

Alignment characteristics of magnetic fields have long been utilized to achieve precision movement and positioning of objects. Early applications include the “Electro Magnetic Motor,” for which Nikola Tesla received U.S. Pat. No. 381,968 on May, 1 1888, based on the principle that a permanent magnet will rotate to maintain its alignment within an external rotating magnetic field. This principle is also the foundation for stepper motors, as demonstrated by Marius Lavet's French Patent 823,395 on Jan. 19, 1938. Stepper motors, which divide a motor's full rotation into discrete steps controlled by the activation and deactivation of electromagnets, offer precise motor position control and are widely used in industrial equipment, positioning systems, packaging machinery, and various commercial products.

Despite the specialized use of magnetic field alignment in industrial and commercial applications, the general application of magnetic fields for precision alignment is limited. Traditional alignment tools such as carpenter's squares and levels are still predominantly used in residential construction, often resulting in imprecise construction techniques that can lead to structural failures, inefficiencies, and increased wear on machined parts. As such, there is a significant amount of wasted time and energy due to the lack of precision assembly processes that involve conventional methods and tools.

Handling and applying magnets also present challenges, particularly in determining magnet polarity and safely applying them without compromising cleanliness or adhesive effectiveness. Traditional methods often require additional devices for polarity determination, making the process cumbersome and inefficient. Individuals with hand strength or dexterity issues face additional difficulties managing small, powerful magnets, increasing the risk of accidental injury or contamination.

The present inventions address these issues by providing user-friendly magnet applicators that may be specifically designed to determine magnet polarity and assist in the safe and efficient application of magnets. These tools may integrate ergonomic design, color-coded polarity indicators, sliding mechanisms for controlled magnet movement, and/or adjustable magnet separators to accommodate various sizes. Additionally, they may feature protective caps resistant to chemicals and heat, ensuring durability and functionality across diverse environments.

### SUMMARY OF THE INVENTIONS

In one aspect, the present inventions comprise magnet applicators that present a revolutionary advancement in the field of hand tools and accessories, specifically designed to overcome the significant challenges associated with magnet polarity determination and safe magnet application. These tools may be meticulously crafted to address the inefficiencies and risks inherent in existing solutions, offering a streamlined and user-friendly experience.

In one aspect, the magnet applicators may comprise a pair of ergonomically designed tools, each embedded with magnets that exhibit opposing magnetic fields. This unique configuration enables users to determine the polarity of both the tool's magnets and external magnets without requiring additional polarity-checking devices. By simplifying the polarity identification process, the tools reduce the potential for human error and improve overall efficiency.

In one aspect, central to the design may be the ergonomic handle, constructed from durable materials such as molded plastic and rubber-coated metal, which may ensure a secure and comfortable grip. In one aspect, this design consideration is beneficial for reducing hand fatigue and enhancing user experience during prolonged use.

In one aspect, the tools may feature color-coded and textured sections for quick and easy polarity identification. These visual and tactile indicators may be especially beneficial for users with visual impairments. Furthermore, in one aspect, the embedded magnets may project through protective caps made from chemically and heat-resistant materials such as silicone or high-density polyethylene. These caps safeguard the magnets from adhesives and environmental factors, maintaining their cleanliness and functionality. When these materials are used for the caps, any adhesive or glue that may come into contact with the caps is less likely to adhere to the caps, and thereby reduce the chances of adhesive build up and/or contamination on the ends of the caps.

In one aspect, a key innovation of the magnet applicators may be the sliding mechanism, comprising a plunger housed within the tool. Controlled by an integrated switch or button, this mechanism may incorporate springs and other mechanical elements to ensure smooth and precise magnet movement. This feature may allow users to position and apply magnets to surfaces safely, keeping their hands at a secure distance from the target area and reducing the risk of injury.

In one aspect, the tools may also include an adjustable magnet separator, featuring jaws operated by levers or pinch mechanisms. This separator can accommodate different magnet sizes, enabling users to separate magnets effortlessly from a stack without direct hand contact. By maintaining the cleanliness of the magnets, this feature may preserve the effectiveness of adhesives used for affixing them.

In one aspect, during operation, users may first identify the polarity by placing the tool near an external magnet and observing the interaction of opposing fields. Next, the separator jaws may be used to lift a single magnet from a stack. The sliding mechanism is then employed to precisely position the magnet at the desired location on a surface. Finally, the magnet is released from the tool by retracting the plunger housing via the switch or button.

In one aspect, the magnet applicators may be designed to withstand repetitive use and harsh environments, ensuring durability and reliability over time. Their innovative design not only addresses the practical challenges of magnet handling but also prioritizes user safety and comfort, making them an invaluable addition to any toolkit.

In one aspect, by providing a comprehensive solution for determining magnet polarity, separating strong magnets, and safely applying them to surfaces, the magnet applicators may represent a significant improvement over traditional methods. These innovations may be particularly advantageous for individuals with limited hand strength or dexterity, offering a safer and more efficient way to handle magnets across various applications.

In another aspect, the present inventions may include a magnet applicator comprising: a main body member having a longitudinal bore therethrough and including a longitudinal slot in an outer wall of the main body member; an upper cap removably engageable with an upper end of the main body member; a slider disposed for movement within the longitudinal bore of the main body member, the slider having a button disposed for movement within the slot in the main body member; and an upper magnet mounted to the slider. Another feature of this aspect of the present inventions may be that the magnet applicator may further include a lower cap removably engageable with a lower end of the main body member, and a lower magnet mounted to the lower cap, the upper magnet having a first polarity, the lower magnet having a second polarity, and the first polarity is opposite of the second polarity. Another feature of this aspect of the present inventions may be that the main body member includes an upper extension member and a lower extension member, the upper cap is removably engageable with the upper extension member, and a lower cap is removably engageable with the lower extension member. Another feature of this aspect of the present inventions may be that the upper cap includes an internal annular ridge disposed in an internal bore of the upper cap, the internal annular ridge on the upper cap being releasable engageable with an upper annular ridge on an outer surface of the upper extension member on the main body member; and the lower cap includes an internal annular ridge disposed in an internal bore of the lower cap, the internal annular ridge on the lower cap being releasable engageable with a lower annular ridge on an outer surface of the lower extension member on the main body member. Another feature of this aspect of the present inventions may be that the main body member includes an upper shoulder adjacent the upper extension member and a lower shoulder adjacent the lower extension member; the internal ridge on the upper cap is adapted for releasable engagement between the upper shoulder on the main body member and the upper annular ridge on the outer surface of the upper extension member; and the internal ridge on the lower cap is adapted for releasable engagement between the lower shoulder on the main body member and the lower annular ridge on the outer surface of the lower extension member. Another feature of this aspect of the present inventions may be that the lower magnet is attached to a lower enclosed surface of the lower cap. Another feature of this aspect of the present inventions may be that the upper magnet is attached to an upper end of the slider, the upper magnet is spaced apart from an upper enclosed end of the upper cap when the slider is in a first position, and the upper magnet is disposed adjacent the upper enclosed end of the upper cap when the slider is in a second position. Another feature of this aspect of the present inventions may be that a lower surface of the button on the slider is engaged with a lower surface of the slot in the main body member when the slider is in the first position, and an upper surface of the button on the slider is engaged with a lower surface of the upper cap when the slider is in the second position.

In another aspect, the present inventions may include a magnet applicator comprising: a main body member having a longitudinal bore therethrough, an upper extension member, and a lower extension member, the main body member including a slot extending into the upper extension member; an upper cap removably engageable with the upper extension member; a lower cap removably engageable with the lower extension member; a slider disposed for movement within the longitudinal bore of the main body member, the slider having a button disposed for movement within the slot in the main body member; an upper magnet mounted to the slider; and a lower magnet mounted to the lower cap. Another feature of this aspect of the present inventions may be that the upper cap includes an internal annular ridge disposed in an internal bore of the upper cap, the internal annular ridge on the upper cap being releasable engageable with an upper annular ridge on an outer surface of the upper extension member on the main body member; and the lower cap includes an internal annular ridge disposed in an internal bore of the lower cap, the internal annular ridge on the lower cap being releasable engageable with a lower annular ridge on an outer surface of the lower extension member on the main body member. Another feature of this aspect of the present inventions may be that the main body member includes an upper shoulder adjacent the upper extension member and a lower shoulder adjacent the lower extension member; the internal ridge on the upper cap is adapted for releasable engagement between the upper shoulder on the main body member and the upper annular ridge on the outer surface of the upper extension member; and the internal ridge on the lower cap is adapted for releasable engagement between the lower shoulder on the main body member and the lower annular ridge on the outer surface of the lower extension member. Another feature of this aspect of the present inventions may be that the upper magnet has a first polarity, the second magnet has a second polarity, and the first polarity of the upper magnet is opposite of the second polarity of the second magnet. Another feature of this aspect of the present inventions may be that the lower magnet is attached to a lower enclosed surface of the lower cap. Another feature of this aspect of the present inventions may be that the upper magnet is attached to an upper end of the slider, the upper magnet is spaced apart from an upper enclosed end of the upper cap when the slider is in a first position, and the upper magnet is disposed adjacent the upper enclosed end of the upper cap when the slider is in a second position. Another feature of this aspect of the present inventions may be that a lower surface of the button on the slider is engaged with a lower surface of the slot in the main body member when the slider is in the first position, and an upper surface of the button on the slider is engaged with a lower surface of the upper cap when the slider is in the second position.

In another aspect, the present inventions may include a magnet applicator comprising: a main body member having a longitudinal bore therethrough and including a longitudinal slot in an outer wall of the main body member; an upper cap removably engageable with an upper end of the main body member; a lower cap removably engageable with a lower end of the main body member; a slider disposed for movement within the longitudinal bore of the main body member, the slider having a button disposed for movement within the slot in the main body member; an upper magnet mounted to the slider, the upper magnet having a first polarity, the upper magnet being attached to an upper end of the slider, the upper magnet is spaced apart from an upper enclosed end of the upper cap when the slider is in a first position, and the upper magnet being disposed adjacent the upper enclosed end of the upper cap when the slider is in a second position; and a lower magnet mounted to a lower enclosed surface of the lower cap, the lower magnet having a second polarity, the first polarity of the upper magnet being opposite of the second polarity of the second magnet. Another feature of this aspect of the present inventions may be that the main body member includes an upper extension member and a lower extension member, the upper cap is removably engageable with the upper extension member, and the lower cap is removably engageable with the lower extension member. Another feature of this aspect of the present inventions may be that the upper cap includes an internal annular ridge disposed in an internal bore of the upper cap, the internal annular ridge on the upper cap being releasable engageable with an upper annular ridge on an outer surface of the upper extension member on the main body member; and the lower cap includes an internal annular ridge disposed in an internal bore of the lower cap, the internal annular ridge on the lower cap being releasable engageable with a lower annular ridge on an outer surface of the lower extension member on the main body member. Another feature of this aspect of the present inventions may be that the main body member includes an upper shoulder adjacent the upper extension member and a lower shoulder adjacent the lower extension member; the internal ridge on the upper cap is adapted for releasable engagement between the upper shoulder on the main body member and the upper annular ridge on the outer surface of the upper extension member; and the internal ridge on the lower cap is adapted for releasable engagement between the lower shoulder on the main body member and the lower annular ridge on the outer surface of the lower extension member. Another feature of this aspect of the present inventions may be that a lower surface of the button on the slider is engaged with a lower surface of the slot in the main body member when the slider is in the first position, and an upper surface of the button on the slider is engaged with a lower surface of the upper cap when the slider is in the second position.

Other features, aspects and advantages of the present inventions will become apparent from the following discussion and detailed description.

### BRIEF DESCRIPTION OF THE DRAWINGS

FIG. 1 is a side view of a magnet applicator in accordance with one aspect of the present inventions.

FIG. 2 is a cross-sectional view taken along line 2-2 of FIG. 1.

FIG. 3 is a cross-sectional view taken along line 3-3 of FIG. 2.

FIG. 4 is a cross-sectional view taken along line 4-4 of FIG. 2.

FIG. 5 is an exploded view of the magnet applicator shown in FIGS. 1-4.

FIG. 6 is a perspective view of an upper portion of a component of the magnet applicator shown in FIG. 5, taken from the view along the line indicated as FIG. 6 in FIG. 5.

FIG. 7A is side view of the magnet applicator shown in FIGS. 1-5 in use to move a button to an upper position which will cause a slider to which the button is attached and an internal magnet that is attached to the slider to be moved to an upper position.

FIG. 7B is a partial side view similar to FIG. 7A, but now with an external magnet positioned adjacent to a tip of the magnet applicator.

FIG. 7C is a partial side view similar to FIG. 7B, but now with the external magnet magnetically attached to a tip of the magnet applicator by virtue of its proximity to the internal magnet.

FIG. 7D is a partial side view similar to FIG. 7C, but now with a layer of adhesive/glue having been applied to an upper surface of the external magnet.

FIG. 7E is a partial side view similar to FIG. 7D after glue has been added to the upper surface of the external magnet and shows that glue-bearing side of the external magnet pressed against a target object to which the user desires to glue the external magnet.

FIG. 7F is a side view similar to FIG. 7E but showing the full length of the magnet applicator and showing the slider button still into is upper position and ready to be pushed downwardly toward its lower position.

FIG. 7G is a view similar to FIG. 7F but now with the button moved to its lower position that has caused the slider and internal magnet to be moved downwardly away from the tip of the magnet applicator and thus away from the external magnet that has been glued to the target object.

FIG. 7H is a side view similar to FIG. 7G, but now with the magnet applicator moved away from the target object and external magnet that has been glued to the target object.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

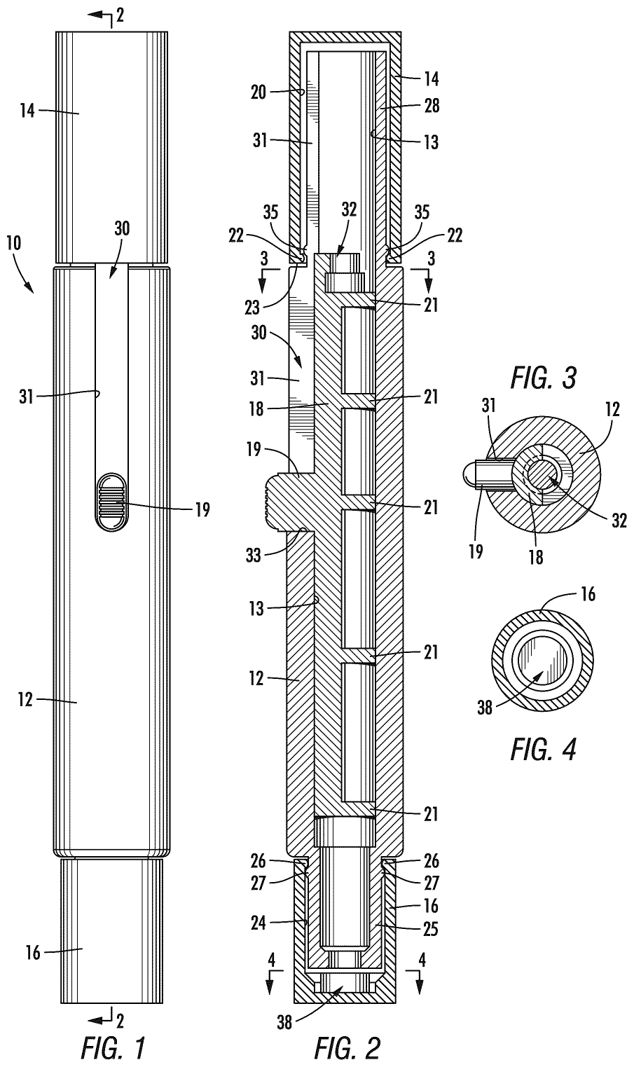

Referring to the drawings in detail, wherein like numerals denote identical elements throughout the several views, and referring initially to FIG. 1, there is shown a specific embodiment of a magnet applicator 10 constructed in accordance with one aspect of the present inventions. In a specific embodiment, the magnet applicator 10 may include a main body member 12, an upper cap 14, a lower cap 16, and a slider 18. With reference to FIG. 2, which is a cross-sectional view taken along line 2-2 of FIG. 1, it can be seen that the main body member 12 includes a longitudinal bore 13 therethrough and a slot 30 defined by sidewalls 31 and having a lower surface 33.

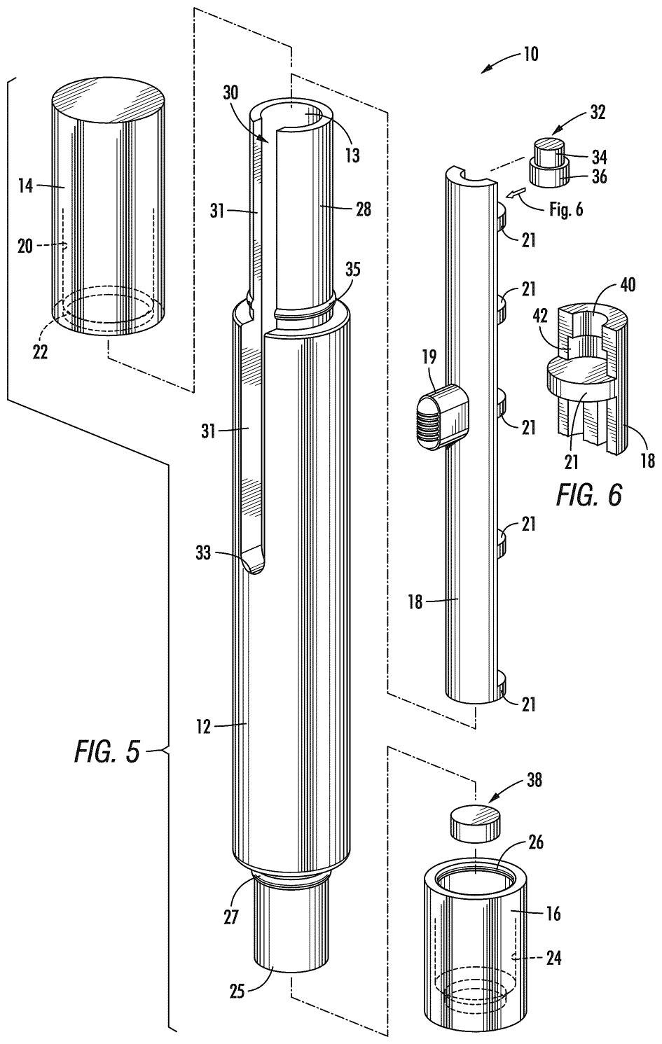

The slider 18 is disposed for longitudinal movement within the longitudinal bore 13 of the main body member 12. As can be seen from FIG. 3, which is a cross-sectional view taken along line 3-3 of FIG. 2, in a specific embodiment, the longitudinal bore 13 of the main body member 12 may have a generally circular cross section and a body member of the slider 18 may also have a generally circular cross-section for mating with the longitudinal bore 13 of the main body member 12. The slider 18 may also have a button 19 disposed for slidable movement within the slot 30 of the main body member 12. As further shown in FIGS. 5 and 6, the slider 18 may have a plurality of disc sections 21 that define the circular cross-section of the slider 18 body member for mating engagement with the longitudinal bore 13 of the main body member 12.

With reference to FIGS. 2 and 5, the main body member 12 may include a lower extension member 25 and an upper extension member 28. A lower shoulder may be defined between the main body member 12 and the lower extension member 25. An upper shoulder may be defined between the main body member 12 and the upper extension member 28. The slot side walls 31 and slot 30 extend upwardly through the upper extension member 28. An outer surface of the lower extension member 25 may include a lower annular ridge 27. In a specific embodiment, the lower annular ridge 27 may be disposed adjacent to the lower shoulder. An outer surface of the upper extension member 28 may include an upper annular ridge 35. In a specific embodiment, the upper annular ridge 35 may be disposed adjacent to the upper shoulder. The purposes of the lower and upper annular ridges 27 and 35 will be explained below in connection with the upper and lower caps 14 and 16.

Referring now to the upper ends of FIGS. 2 and 5, it can be seen that the upper cap 14 may be in the form of a cylinder and include an internal bore 20 extending upwardly from a lower open end of the upper cap 14 toward an upper enclosed end of the upper cap 14. The internal bore 20 of the upper cap 14 may include an internal annular ridge 22 adapted for mating engagement with a lower surface of the upper annular ridge 35 on the exterior surface of the upper extension member 28 and with an upper surface of the upper shoulder of the main body member 12. In this manner, the upper cap 14 can be snapped into place and held in place around the upper extension member 28. It can also be easily detached for easy access to the internal components of the magnet applicator 10.

Referring now to the lower ends of FIGS. 2 and 5, it can be seen that the lower cap 16 may be in the form of a cylinder and include an internal bore 24 extending downwardly from an upper open end of the lower cap 16 toward a lower enclosed end of the lower cap 16. The internal bore 24 of the lower cap 16 may include an internal annular ridge 26 adapted for mating engagement with an upper surface of the lower annular ridge 27 on the exterior surface of the lower extension member 25 and with a lower surface of the lower shoulder of the main body member 12. In this manner, the lower cap 16 can be snapped into place and held in place around the lower extension member 28. It can also be easily detached for easy access to the internal components of the magnet applicator 10.

In a specific embodiment, the magnet applicator 10 may include an upper magnet 32. In another specific embodiment, the magnet application 10 may also include a lower magnet 38. As shown for example in FIGS. 2 and 5, the upper magnet 32 may include a base 36 and a relatively smaller upper end 34. As shown in FIG. 6, which is a view looking toward the upper end of the slider 18 as indicated by the arrow labeled FIG. 6 in FIG. 5, in a specific embodiment, the upper end of the slider 18 may be adapted for mating engagement with the upper magnet 34. As shown in FIG. 6, the upper end of the slider 18 may include a first half-moon recess 42 adjacent an upper surface of an upper disc 21 and a second half-moon recess 40 adjacent the first half-moon recess 42 and an upper surface of the slider 18. In this manner, the base 36 of the upper magnet 32 may rest on an upper surface of the disc 21 and engage in mating contact with the first half-moon recess 42 as the upper end 34 of the upper magnet 32 engages in mating contact with the second half-moon recess 40. In a specific embodiment, a first radius of the first half-moon recess 42 may be greater than a second radius of the second half-moon recess 40. As shown at the lower ends of FIGS. 2 and 5, the lower magnet 38 may be positioned in a receptacle adjacent the lower enclosed end of the lower cap 16. In a specific embodiment, the shape of the upper magnet 32 may be in the shape of a disc like the lower magnet 38.

The slider 18 may be moveable between a first position and a second position. The first position is shown in FIGS. 1 and 2, in which the upper magnet 32 is spaced apart from the upper enclosed end of the upper cap 14, and a lower surface of the button 19 is engaged with a lower surface 33 of the slot 30. The second position is shown in 7B, and shows the upper magnet 32 disposed adjacent the upper enclosed end of the upper cap 14, and an upper surface of the slide button 19 engaged with a lower surface 23 of the upper cap 14. When in this position, the upper magnet 32 can be positioned adjacent an external magnet in order to determine the polarity of the another magnet, and/or to magnetically attract and pick up an external magnet for connection to a target object, such as by using an adhesive such as glue.

FIGS. 1-5 showcase the ergonomic design of the magnet applicator 10. The applicator 10 may feature an ergonomic handle 12, designed to comfortably fit in a user's hand, reducing strain during prolonged use. The handle or main body member 12 may be contoured to support users with varying hand sizes and dexterity levels.

The upper and lower caps 14 and 16 may be color-coded to assist in identification of polarity for the upper and lower magnets 32 and 38. The color-coded sections may be prominently visible, facilitating straightforward polarity identification. For example, the north pole or upper magnet 32 might be indicated by a blue upper cap 14, while the south pole or lower magnet 38 could be marked by a red lower cap 16. In this specific embodiment, this color-coding system may be used to simplify the process of determining magnet polarity without the need for additional devices. The magnets 32 and 38 may also having colors that match the colors of the corresponding caps 14 and 16. Other approaches to matching the magnets 32/38 to their respective caps 14/16 may include matching textures or other visual and tactile indicators to denote positive and negative polarities. In a specific embodiment, the magnet applicator 10 only needs at least one magnet 32 or 38. In a specific embodiment, the magnet applicator 10 may include the upper magnet 32 that is attached to the upper end of the slider 18. In a specific embodiment, the magnet applicator 10 may include the lower magnet 28 that is attached to the lower cap 16. In a specific embodiment, the magnet applicator 10 may include both the upper magnet 32 and the lower magnet 38.

The slider 18 is shown including a visible switch or button 19 and corresponding groove or slot 30 in the main body member 12 that allow the user to easily control the movement of the internal upper magnet 32. In this manner, the magnet applicator 10 may provide precise positioning and handling of the upper magnet 32, enabling safe and efficient application.

FIG. 5 exhibits an exploded view of the magnet applicator 10 illustrating its internal components. FIG. 5 dissects the magnet applicator 10, providing a detailed view of the internal architecture. Components of the magnet applicator 10 may include the slider 18, embedded magnets 32 and 38, and protective caps 14 and 16. In a specific embodiment the magnet applicator 10 may also include magnet separator mechanisms.

Embedded magnets 32 and 38 are integrated within the magnet applicator 10, and may be positioned to align with external color-coded sections for easy polarity determination. In a specific embodiment, the magnets 32 and 38 may generate opposing magnetic fields, a feature that can be important for accurate polarity identification.

The upper and lower protective caps 14 and 16 cover the ends of the magnet applicator 10, and are designed to assist in safeguarding the internal magnets 32 and 38 from external contaminants. The caps 14 and 16 may be constructed from materials resistant to chemicals and heat, thus facilitating the durability and functionality of the magnet applicator 10 in various environments. For instance, in a specific embodiment, the caps 14 and 16 may be constructed to withstand exposure to industrial solvents or high-temperature conditions without degrading. In a specific embodiment, the caps 14 and 16 may be constructed from materials such as silicone or high-density polyethylene.

The magnet separator mechanisms may be adjustable components designed to accommodate and separate magnets of different sizes. By adjusting these separators, users can handle and apply various magnets without direct contact, maintaining the cleanliness and effectiveness of adhesives. This feature may reduce the risk of contamination or injury during the application process.

Additionally, the exploded view of FIG. 5 shows how the ergonomic handle houses the internal mechanisms, providing user comfort while ensuring the operational efficiency of the magnet applicator 10.

In a specific embodiment, the tool handle or main body member 12 may be ergonomically designed to fit comfortably in a user's hand, utilizing materials like molded plastic or rubber-coated metal for a secure grip. In a specific embodiment, embedded within the magnet applicator 10 is a magnet 32 and/or 38 oriented to project through a chemically and heat-resistant protective cap 14 or 16, made from materials such as silicone or high-density polyethylene, ensuring protection from adhesives and environmental factors. The slider 18 may comprise a plunger housing the upper magnet 32, controlled via a switch or button 19 integrated into the slider 18. In a specific embodiment, the slider 18 may incorporate springs and other mechanical elements for smooth and precise movement. In a specific embodiment, the button 19 could be a rotatable knob that may be linked to the slider 18 via a gear so that rotation of the knob 19 would move the slider 19 up and down with the main body member 12 between its lower and upper positions. In another specific embodiment, instead of using natural magnets, the magnets 32 and 38 could be electromagnetics and the button 19 could be a push-button to activate a solenoid connected to an on-board power source (e.g., a battery) that will activate the magnet via an electronic control mechanism. Other embodiments may include a spring mechanism, a swiveling mechanism, a spinning mechanism, a method of magnetizing surfaces, a locking mechanism, viewing windows to view the internal magnets, and adjustable caps.

A secondary magnet 38 at the back or lower end of the magnet applicator 10 may stabilize it during operation. Color-coded or textured sections of the magnet applicator 10 may indicate the polarity, allowing quick identification. The magnet separator may feature adjustable jaws to fit various magnet sizes, operated by levers or pinch mechanisms, enabling users to separate magnets without manual handling. The separator's adjustable nature accommodates different magnet dimensions, ensuring versatility across applications.

The magnet applicator 10 may be constructed from molded plastic or rubber-coated metal, ensuring an ergonomic handle that offers a secure and comfortable grip. The design may be contoured to fit various hand sizes, minimizing fatigue during extended use. Embedded magnets 32 and/or 38 within the tool may be oriented to project through protective caps 14 and 16 made from chemically and heat-resistant materials such as silicone or high-density polyethylene. These caps 14 and 16 may shield the magnets 32 and 38 from adhesives and environmental factors while featuring transparent viewing windows for better visibility.

In a specific embodiment, the slider 18 may consist of a plunger that encases the upper magnet 32, designed for smooth and precise movement due to integrated springs and mechanical components. The position of the upper magnet 32 within the magnet applicator 10 may be controlled by a switch or button 29 located on the slider 18. A secondary magnet 38 situated at the back or lower end of the magnet applicator 10 may balance it during operation, enhancing user control. The lower magnet 38 may also be used to pick up and place magnets having an opposite polarity to the lower magnet 38. In a specific application, a user may choose to use two magnet applicators 10 (or a pair of magnet applicators 10), one for picking up and placing magnets having a north pole (in which case the upper magnet 32 is a south pole), and another one for picking up and placing magnets having a south pole (in which case the upper magnet is a north pole).

Color-coded sections and textured areas on the magnet applicator 10 may aid in quick polarity identification, benefiting users with visual impairments. In various specific embodiments, the adjustable magnet separator, featuring jaws operated by levers or pinch mechanisms, can accommodate various magnet sizes. This may enable the effortless separation of magnets from a stack, preserving their cleanliness by avoiding direct hand contact.

During operation, users place the magnet applicator 10 near an external magnet to determine polarity through the interaction of opposing fields. The separator jaws lift a single magnet from a stack, and the slider 18 allows precise positioning of the magnet at the target surface. The magnet is then released by retracting the slider plunger housing through the switch or button 19. The design ensures that hands remain at a safe distance from magnets, reducing the risk of pinching or injury, especially for individuals with limited dexterity. The magnet applicators 10 may be constructed to withstand repetitive use and harsh environments, ensuring durability and reliability over time.

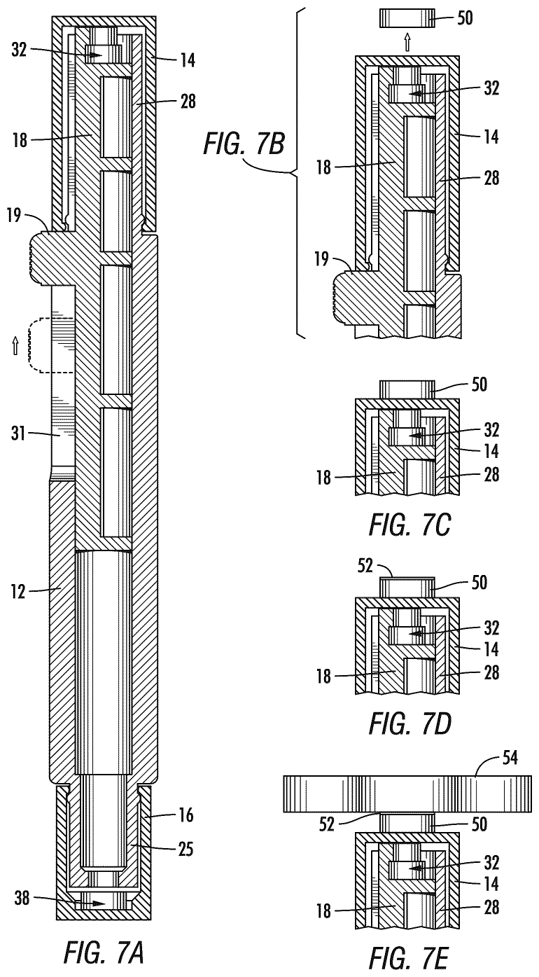

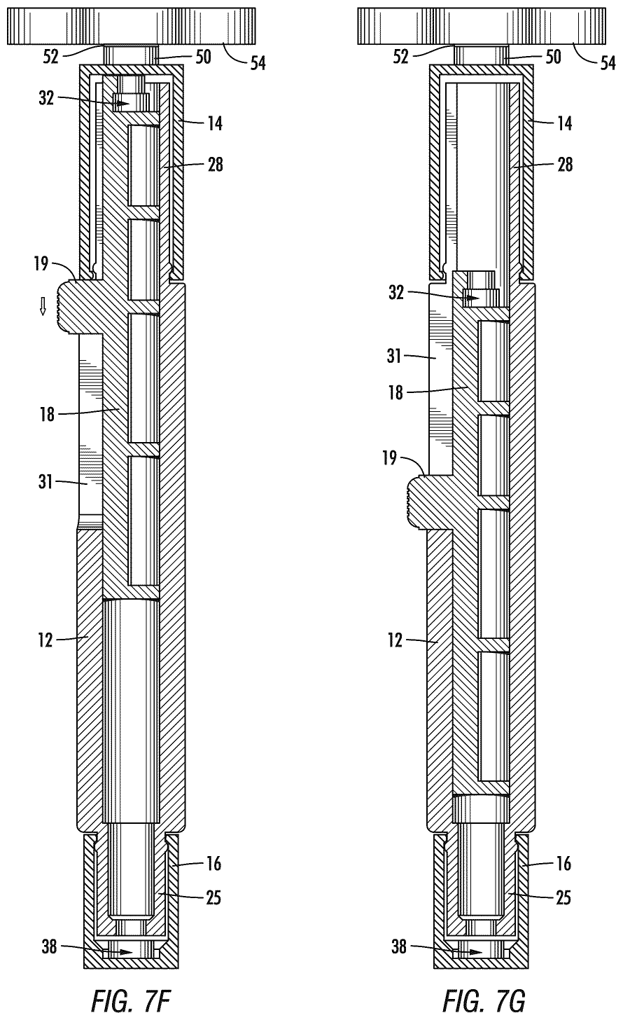

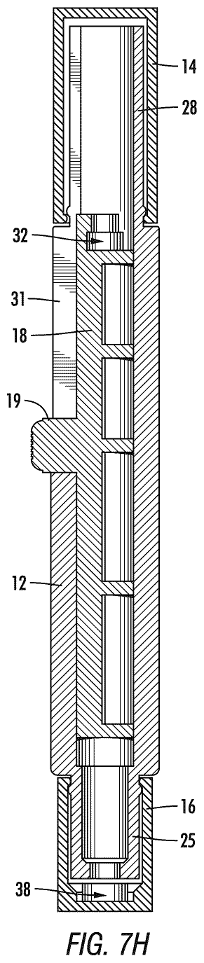

With reference to FIGS. 7A-7H, a method of using an embodiment of the magnet applicator 10 is illustrated. An example use case for the magnet applicator 10 may be in connection with hobbies, such as tabletop war gaming. For example, the toy models, such as of a soldier, may be separated into components parts, such as a head, a torso, a right arm, a left arm, a right leg, and a right arm. Each of those pieces may have a hole drilled out at a logical connection point for matching members. For example, there may be a hole at the right shoulder and a corresponding hole at the upper end of the right arm. It may be desired to place a small magnet, sometimes referred to as a wafer magnet (or for present purposes an external magnet) in the holes. For example, there could be one magnet placed and glued into the hole at the right shoulder, and then a corresponding magnet of opposite polarity may be placed in the corresponding hole at the upper end of the right arm. It can be tedious and somewhat messy to do this by hand. One of the problems when doing this by hand is that the magnets are so small they are difficult to pick up. Another problem is that when a user's finger touches the external magnet, the face of the external magnet to be glued could become contaminated with oil or residue from the user's finger. Such oil will interfere with the ability of the glue to adhere to the face of the external magnet, thereby interfering with the strength of the glue bond between the external magnet and the bonding surface of the target hole, such as the hole that was drilled into the right shoulder and the upper end of the right arm in the example discussed here. The magnet applicator 10 may be used to avoid these problems, as explained below.

Referring now to FIG. 7A, a side view of the magnet applicator 10 shown in use to move the button 19 to its upper position, which will cause the slider 18 to which the button 19 is attached, and the internal upper magnet 32 that is attached to the slider 18, to be moved to an upper position. In this position, the upper magnet 32 is positioned adjacent the upper enclosed surface of the upper cap 14. FIG. 7B shows an external magnet 50 positioned adjacent the upper end or tip of the magnet applicator. FIG. 7C is a partial side view similar to FIG. 7B, but now with the external magnet 50 magnetically attached to the upper surface of the upper cap 14 of the magnet applicator 10 by virtue of its proximity to the internal upper magnet 32. FIG. 7D is a partial side view similar to FIG. 7C, but now with a layer of adhesive 52 applied to an upper surface of the external magnet 50. FIG. 7E is a side view similar to FIG. 7D after glue 52 has been added to an the upper surface of the external magnet 50 and shows the glue-bearing side of the external magnet 50 pressed against a target object 54 to which the user desires to glue the external magnet. The target object 54 could be any structure. To use the above example, it could be one of the drilled holes in one of the body parts of the toy soldier. FIG. 7F is a view similar to FIG. 7E, but now showing the full length of the magnet applicator 10, and showing the slider button 19 ready to be pushed downwardly from its upper position as shown toward its lower position. FIG. 7G is a view similar to FIG. 7F, but now with the button 19 moved to its lower position, which has caused the slider 18 and internal magnet 32 to be moved downwardly away from the upper tip of the magnet applicator 10 and thus away from the external magnet 50 that has been glued to the target object 54. FIG. 7H is a side view similar to FIG. 7G, but now with the magnet applicator moved away from the target object 54 and external magnet 50 that has been glued to the target object 54.

As mentioned above, the magnet applicators 10 may be used in pairs and have color-coded caps 14 and 16 to indicate polarity of the internal magnet 32, with one of the magnet applicators 10 having a north pole internal magnet 32 and the other one having a south pole internal magnet 32. In this example, and using the toy soldier example above, the north pole magnet applicator 10 could be used to place a south pole magnet in the shoulder recess, and the south pole could be used to place a north pole magnet in the adjoining arm recess. In this manner, the arm magnet and the shoulder magnet would be magnetically attracted to each other thus the arm would be magnetically affixed to the torso at the shoulder.

While the adjustable magnet separators are described for preventing direct hand contact and maintaining adhesive cleanliness, they could be engineered to include additional features such as magnetic shielding or insulation to further enhance safety and functionality in specialized applications.

Additionally, the embedded magnets 32 and 38 could be substituted with magnets of different strengths, shapes, or magnetic field configurations to cater to specific tasks. For instance, stronger magnets might be used for industrial applications requiring robust magnetic fields, while smaller, more precise magnets could be employed in delicate electronic applications. Further, the lower magnet 38 may serve one or more functions. As one example, the lower magnet 38 could serve as a back-up magnet in the event the user is using a pair of magnet applicators 10 and one of them is lost. In that case, the back-up magnet 38, which would have a polarity opposite of the polarity of the upper magnet 32, could be used instead of the lost magnet applicator 10. Another function of the lower magnet 38 may be to serve a storage function, such as to hold a stack of external magnets that are being glued to various target objects.

These examples illustrate that the core principles and functionalities of the magnet applicators 10 are open to various adaptations and enhancements. Such modifications ensure that the inventions remain versatile and capable of meeting evolving technological demands and user needs. Consequently, the inventions' scope should be defined by the appended claims and equivalents thereof, rather than being limited strictly to the specific embodiments described herein.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. For example, in one aspect, an ergonomic handle's design can be adapted for different user preferences or specific industrial requirements. The handle could be made with alternative materials, such as rubber, plastic, or composite materials tailored for greater durability, enhanced grip, or lighter weight to suit particular applications. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A magnet applicator comprising:
a main body member having a longitudinal bore therethrough and including a longitudinal slot in an outer wall of the main body member;
an upper cap removably engageable with an upper end of the main body member;
a slider disposed for movement within the longitudinal bore of the main body member, the slider having a button disposed for movement within the slot in the main body member; and
an upper magnet mounted to the slider.

2. The magnet applicator of claim 1, further including a lower cap removably engageable with a lower end of the main body member, and a lower magnet mounted to the lower cap, the upper magnet having a first polarity, the lower magnet having a second polarity, and the first polarity is opposite of the second polarity.

3. The magnet applicator of claim 1, wherein the main body member includes an upper extension member and a lower extension member, the upper cap is removably engageable with the upper extension member, and a lower cap is removably engageable with the lower extension member.

4. The magnet applicator of claim 3, wherein:
the upper cap includes an internal annular ridge disposed in an internal bore of the upper cap, the internal annular ridge on the upper cap being releasable engageable with an upper annular ridge on an outer surface of the upper extension member on the main body member; and
the lower cap includes an internal annular ridge disposed in an internal bore of the lower cap, the internal annular ridge on the lower cap being releasable engageable with a lower annular ridge on an outer surface of the lower extension member on the main body member.

5. The magnet applicator of claim 4, wherein:
the main body member includes an upper shoulder adjacent the upper extension member and a lower shoulder adjacent the lower extension member;
the internal ridge on the upper cap is adapted for releasable engagement between the upper shoulder on the main body member and the upper annular ridge on the outer surface of the upper extension member; and
the internal ridge on the lower cap is adapted for releasable engagement between the lower shoulder on the main body member and the lower annular ridge on the outer surface of the lower extension member.

6. The magnet applicator of claim 2, wherein the lower magnet is attached to a lower enclosed surface of the lower cap.

7. The magnet applicator of claim 1, wherein the upper magnet is attached to an upper end of the slider, the upper magnet is spaced apart from an upper enclosed end of the upper cap when the slider is in a first position, and the upper magnet is disposed adjacent the upper enclosed end of the upper cap when the slider is in a second position.

8. The magnet applicator of claim 7, wherein a lower surface of the button on the slider is engaged with a lower surface of the slot in the main body member when the slider is in the first position, and an upper surface of the button on the slider is engaged with a lower surface of the upper cap when the slider is in the second position.

9. A magnet applicator comprising:
a main body member having a longitudinal bore therethrough, an upper extension member, and a lower extension member, the main body member including a slot extending into the upper extension member;
an upper cap removably engageable with the upper extension member;
a lower cap removably engageable with the lower extension member;
a slider disposed for movement within the longitudinal bore of the main body member, the slider having a button disposed for movement within the slot in the main body member;
an upper magnet mounted to the slider; and
a lower magnet mounted to the lower cap.

10. The magnet applicator of claim 9, wherein:
the upper cap includes an internal annular ridge disposed in an internal bore of the upper cap, the internal annular ridge on the upper cap being releasable engageable with an upper annular ridge on an outer surface of the upper extension member on the main body member; and
the lower cap includes an internal annular ridge disposed in an internal bore of the lower cap, the internal annular ridge on the lower cap being releasable engageable with a lower annular ridge on an outer surface of the lower extension member on the main body member.

11. The magnet applicator of claim 10, wherein:
the main body member includes an upper shoulder adjacent the upper extension member and a lower shoulder adjacent the lower extension member;
the internal ridge on the upper cap is adapted for releasable engagement between the upper shoulder on the main body member and the upper annular ridge on the outer surface of the upper extension member; and
the internal ridge on the lower cap is adapted for releasable engagement between the lower shoulder on the main body member and the lower annular ridge on the outer surface of the lower extension member.

12. The magnet applicator of claim 9, wherein the upper magnet has a first polarity, the second magnet has a second polarity, and the first polarity of the upper magnet is opposite of the second polarity of the second magnet.

13. The magnet applicator of claim 9, wherein the lower magnet is attached to a lower enclosed surface of the lower cap.

14. The magnet applicator of claim 9, wherein the upper magnet is attached to an upper end of the slider, the upper magnet is spaced apart from an upper enclosed end of the upper cap when the slider is in a first position, and the upper magnet is disposed adjacent the upper enclosed end of the upper cap when the slider is in a second position.

15. The magnet applicator of claim 14, wherein a lower surface of the button on the slider is engaged with a lower surface of the slot in the main body member when the slider is in the first position, and an upper surface of the button on the slider is engaged with a lower surface of the upper cap when the slider is in the second position.

16. A magnet applicator comprising:
a main body member having a longitudinal bore therethrough and including a longitudinal slot in an outer wall of the main body member;
an upper cap removably engageable with an upper end of the main body member;
a lower cap removably engageable with a lower end of the main body member;
a slider disposed for movement within the longitudinal bore of the main body member, the slider having a button disposed for movement within the slot in the main body member;
an upper magnet mounted to the slider, the upper magnet having a first polarity, the upper magnet being attached to an upper end of the slider, the upper magnet is spaced apart from an upper enclosed end of the upper cap when the slider is in a first position, and the upper magnet being disposed adjacent the upper enclosed end of the upper cap when the slider is in a second position; and
a lower magnet mounted to a lower enclosed surface of the lower cap, the lower magnet having a second polarity, the first polarity of the upper magnet being opposite of the second polarity of the second magnet.

17. The magnet applicator of claim 16, wherein the main body member includes an upper extension member and a lower extension member, the upper cap is removably engageable with the upper extension member, and the lower cap is removably engageable with the lower extension member.

18. The magnet applicator of claim 17, wherein:
the upper cap includes an internal annular ridge disposed in an internal bore of the upper cap, the internal annular ridge on the upper cap being releasable engageable with an upper annular ridge on an outer surface of the upper extension member on the main body member; and
the lower cap includes an internal annular ridge disposed in an internal bore of the lower cap, the internal annular ridge on the lower cap being releasable engageable with a lower annular ridge on an outer surface of the lower extension member on the main body member.

19. The magnet applicator of claim 18, wherein:
the main body member includes an upper shoulder adjacent the upper extension member and a lower shoulder adjacent the lower extension member;
the internal ridge on the upper cap is adapted for releasable engagement between the upper shoulder on the main body member and the upper annular ridge on the outer surface of the upper extension member; and
the internal ridge on the lower cap is adapted for releasable engagement between the lower shoulder on the main body member and the lower annular ridge on the outer surface of the lower extension member.

20. The magnet applicator of claim 16, wherein a lower surface of the button on the slider is engaged with a lower surface of the slot in the main body member when the slider is in the first position, and an upper surface of the button on the slider is engaged with a lower surface of the upper cap when the slider is in the second position.
